(19) United States
(12) Patent Application Publication
(10) Pub. No.: US 2024/0317358 A1
(43) Pub. Date: Sep. 26, 2024

(54) SPLINED TORQUE TRANSFER HUB

(71) Applicant: Polaris Industries Inc., Medina, MN (US)

(72) Inventors: Michael J. Whiting, North Branch, MN (US); Jeffrey I. Peterman, Stacy, MN (US); Amery D. Kuhl, North Branch, MN (US)

(73) Assignee: Polaris Industries Inc., Medina, MN (US)

(21) Appl. No.: 18/603,455

(22) Filed: Mar. 13, 2024

Related U.S. Application Data
(60) Provisional application No. 63/453,173, filed on Mar. 20, 2023.

(51) Int. Cl. B62M 9/02; B60B 27/04

(52) U.S. Cl. CPC B62M 9/02; B60B 27/04

(57) ABSTRACT

A sprocket assembly is described. The assembly includes a sprocket having an outer wheel with engaging members connected to a central hub including a first hub opening having a first diameter and a second hub opening having a smaller second diameter, and a hub including an alignment portion and an engagement portion that together define an axle opening for receiving an axle of a vehicle. The alignment portion incudes a smooth outer surface sized to be press fit into the second hub opening, and the engagement portion includes forming splines positioned to deform an inner surface of the first hub opening as the alignment portion is press fit into the second hub opening to form engagement splines on the inner surface that correspond to the splines. The hub is formed from a first material and the sprocket is formed from a less durable second material.

### CROSS-REFERENCE TO RELATED APPLICATION

The present application claims the benefit of U.S. Provisional Application No. 63/453,173 entitled “SPLINED TORQUE TRANSFER HUB,” filed on Mar. 20, 2023, which is incorporated by reference herein for all purposes in its entirety.

### TECHNICAL FIELD

The present disclosure relates to torque transfer devices and more particularly to a sprocket assembly for a vehicle having a light-weight sprocket coupled to a durable hub.

### BACKGROUND

This section provides background information related to the present disclosure which is not necessarily prior art. It is known to transfer torque generated by an engine though a belt or chain to a sprocket connected to an axle of a vehicle. In some applications, the sprocket includes internal splines that engage external splines on the axle. The high shear loads generated in certain vehicle configurations apply substantial force to the splines. Typical conventional sprockets are made from steel to accommodate these high loads, however, the all-steel designs are heavy, and weight is a substantial consideration in certain vehicle designs. For example, some government requirements for a vehicle to be classified as an autocycle require that the vehicle be below a certain weight. In some applications a lightweight, all-aluminum sprocket is used with corresponding torque transfer components to avoid overloading the sprocket. For example, in some motorcycle applications, an all-aluminum sprocket is used with a cush drive, which includes a rubber damper system between the wheel and the sprocket assembly to damp the transfer of torque between the sprocket and wheel during gear and throttle changes. These drive train configurations, however, require a large number of parts and assembly steps, and can be expensive and prone to wear. It would be desirable to provide a light-weight sprocket assembly (relative to an all-steel design) that could accommodate the high shear loads of an autocycle, for example, without requiring the additional parts, complexity and cost associated with the use of conventional torque transfer techniques.

### SUMMARY

In one embodiment, the present disclosure provides a sprocket assembly, comprising: a sprocket having an outer wheel with engaging members connected to a central hub including a first hub opening having a first diameter and a second hub opening having a second diameter that is less than the first diameter; and a hub including an alignment portion and an engagement portion that together define an axle opening for receiving an axle of a vehicle, the alignment portion including a smooth outer surface sized to be press fit into the second hub opening, and the engagement portion including a plurality of forming splines positioned to deform an inner surface of the first hub opening as the alignment portion is press fit into the second hub opening to form engagement splines on the inner surface that correspond to the splines; wherein the hub is formed from a first material and the sprocket is formed from a second material that is less durable than the first material. In one aspect of this embodiment, the first and the second hub openings are substantially cylindrical. In another aspect, the central hub includes a wall that defines the first and the second hub openings and a shoulder positioned between the first and the second hub openings. In a variant of this aspect, the hub includes a shoulder positioned between the engagement portion and the alignment portion, the shoulder of the hub engaging the shoulder of the central hub when the hub is fully seated within the sprocket. In another aspect, the central hub includes a wall that defines a relief groove between the first hub opening and the second hub opening, the relief groove being positioned to receive debris formed as the forming splines deform the inner surface of the first hub opening. In another aspect, the alignment portion includes a cylindrical wall having an outer annular chamfer adjacent an outer end of the cylindrical wall, the outer annular chamfer providing a lead in surface as the alignment portion is pressed into the first cylindrical opening of the central hub. In still another aspect, the alignment portion includes a cylindrical wall having a first portion of substantially constant diameter and a second portion that tapers with distance from the first portion toward an outer end of the cylindrical wall. In yet another aspect, the engagement portion includes a cylindrical wall having an outer surface including the forming splines, an inner surface corresponding to the axle opening, an inner end and an outer end. In a variant of this aspect, the alignment portion includes an inner surface, the inner surface of the alignment portion and the inner surface of the engagement portion including a plurality of driving splines configured to engage corresponding splines on an outer surface of the axle. In a further variant, the inner end of the cylindrical wall of the engagement portion includes an outer annular chamfer and the first hub opening includes an annular inlet chamfer, the outer annular chamfer and the annular inlet chamfer providing lead in surfaces as the engagement portion is pressed into the first hub opening. In another aspect of this embodiment, the engagement portion includes a cylindrical wall having an inner end and an outer end, and an outer diameter of the engagement portion being defined by the forming splines. In another aspect, the first material is steel and the second material is aluminum.

In another embodiment, the present disclosure provides a method of forming a sprocket assembly, comprising: forming a hub from a first material; forming a sprocket from a second material that is less durable than the first material; and press fitting the hub into the sprocket; wherein press fitting includes press fitting a smooth outer surface of an alignment portion of the hub into a second hub opening of the sprocket and press fitting a plurality of forming splines disposed on an outer surface of an engagement portion of the hub into an inner surface of a first hub opening of the sprocket, the forming splines deforming the inner surface of the first hub opening, the first hub opening having a diameter that is larger than a diameter of the second hub opening. In one aspect of this embodiment, the press fitting of the smooth outer surface of the alignment portion of the hub occurs before the press fitting of the plurality of forming splines of the engagement portion of the hub such that the press fitting of the smooth outer surface of the alignment portion maintains the hub in alignment with a longitudinal axis of the sprocket assembly.

In yet another embodiment, the present disclosure provides a sprocket assembly, comprising: a sprocket including a central hub defining a hub opening; and a hub including an alignment portion and an engagement portion that together define an axle opening for receiving an axle of a vehicle, the alignment portion including a smooth outer surface press fit into the one portion of the hub opening, and the engagement portion including a plurality of forming splines engaged with an inner surface of the hub opening formed by the forming splines as the hub is press fit into the central hub of the sprocket; wherein the hub is formed from a first material and the sprocket is formed from a second material that is less durable than the first material. In one aspect of this embodiment, the hub opening includes a first cylindrical hub opening having a first diameter and a second cylindrical hub opening having a second diameter that is smaller than the first diameter. In another aspect, the central hub includes a wall that defines a first hub opening, a second hub opening and a shoulder positioned between the first hub opening and the second hub opening. In a variant of this aspect, the hub includes a shoulder positioned between the engagement portion and the alignment portion, the shoulder of the hub engaging the shoulder of the central hub when the hub is fully seated within the sprocket. In another aspect, the central hub includes a wall that defines a relief groove adjacent the one portion of the hub opening, the relief groove being positioned to receive debris formed as the forming splines deform the inner surface of the hub opening. In yet another aspect of this embodiment, the engagement portion includes a cylindrical wall having an inner end and an outer end, an outer diameter of the engagement portion defined by the forming splines is substantially constant. In a further aspect, the first material is steel and the second material is aluminum.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a vehicle including a sprocket-driven rear axle;

FIG. 2 is a cross-sectional, perspective view of a sprocket assembly according to the present disclosure;

FIG. 3 is a partial, perspective view of a sprocket according to the present disclosure;

FIG. 4 is a perspective view of a hub according to the present disclosure;

FIG. 5 is a side, cross-sectional view of a portion of the hub of FIG. 4 and a portion of the sprocket of FIG. 3;

FIG. 6 is an enlarged view of a portion of FIG. 5;

FIG. 7 is a side, cross-sectional view of a portion of the hub of FIG. 4 fully seated within a portion of the sprocket of FIG. 3; and

FIG. 8 is an enlarged view of a portion of the hub of FIG. 4.

Corresponding reference numerals indicate corresponding parts throughout the several views of the drawings.

### DETAILED DESCRIPTION

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples,” “coupled,” “coupler,” and variations thereof are used to include both arrangements wherein two or more components are in direct physical contact and arrangements wherein the two or more components are not in direct contact with each other (e.g., the components are “coupled” via at least a third component, but still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

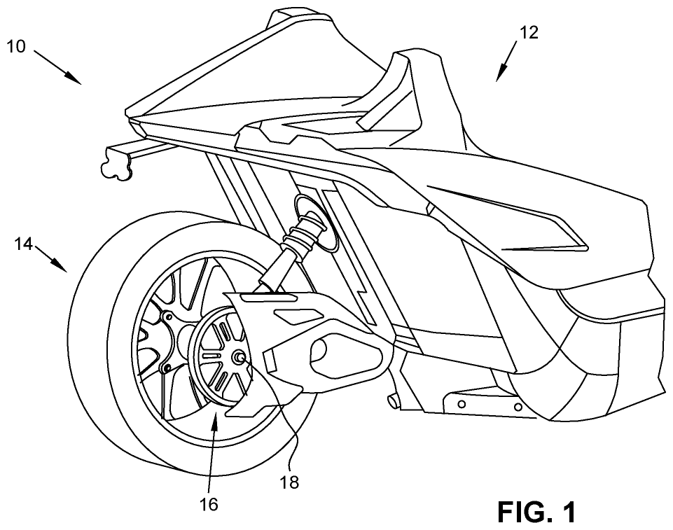

Referring now to FIG. 1, a portion of a vehicle 10, in this example an autocycle, is shown including a body 12 and a wheel 14 which is driven by an engine (not shown) through a belt (not shown) that meshes with a sprocket 16. In this rear-wheel drive example, the sprocket 16 is coupled to a rear axle 18 such that torque is transferred from the engine, through the belt, to the sprocket 16 and the rear axle 18 to the wheel 14 to propel the vehicle 10. While the vehicle 10 depicted in FIG. 1 is an autocycle, it should be understood that the disclosure of the present invention may have application on any of a variety of vehicles having driven sprockets in the drive train such as, but not limited to, various types of all-terrain vehicles, utility task vehicles, snowmobiles, motorcycles, etc. Additionally, the teachings of the present disclosure may also be applied to vehicles having chain drive sprockets, vehicles with multiple driven wheels, front-wheel drive vehicles and/or all-wheel drive vehicles.

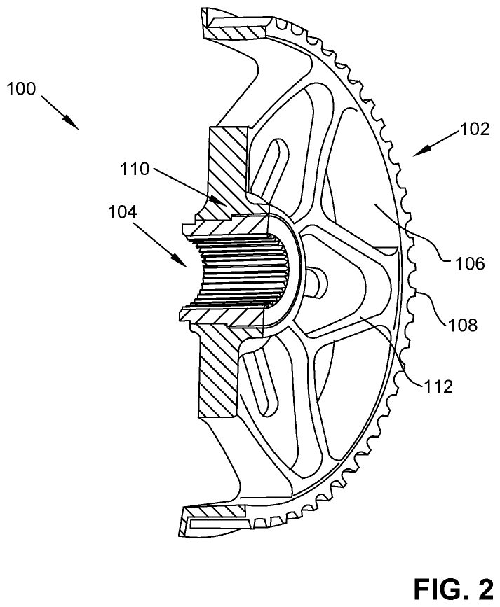

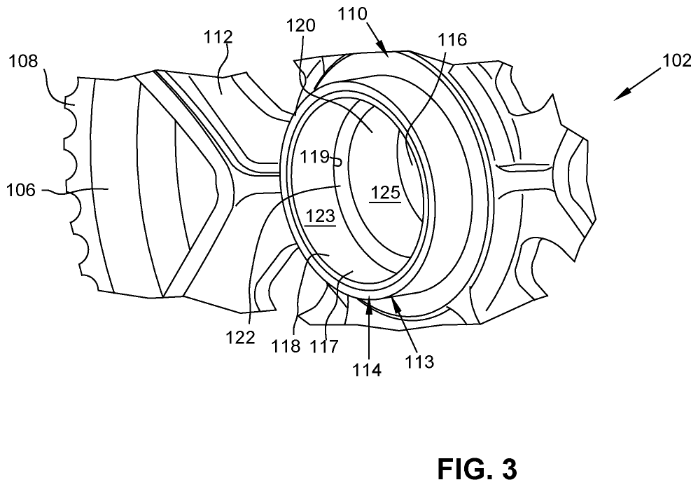

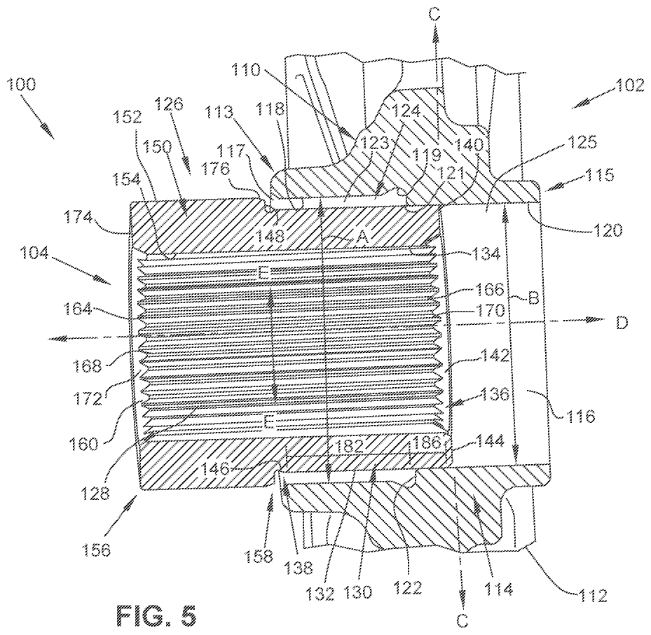

Referring now to FIG. 2, a cross-sectional view of a sprocket assembly 100 according to the present disclosure is shown. Sprocket assembly 100 generally includes a sprocket 102 and a hub 104. The sprocket 102 includes an outer wheel 106 having a plurality of engaging members or teeth 108 for engaging with corresponding notches (not shown) on a belt (not shown), a central hub 110 and a plurality of spokes 112 extending between the central hub 110 and the outer wheel 106. As best shown in FIG. 3, the central hub 110 generally includes a wall 114 that forms a hub opening 116 including a first cylindrical hub opening 118, a second cylindrical hub opening 120 and a shoulder 122 between the first cylindrical hub opening 118 and the second cylindrical hub opening 120. The first cylindrical hub opening 118 includes an inner surface 123 and the second cylindrical hub opening 120 includes an inner surface 125. As best shown in FIG. 5, the first cylindrical hub opening 118 has a diameter A that is larger than a diameter B of the second cylindrical hub opening 120.

An annular inlet chamfer 121 is formed at a transition between the shoulder 122 and the second cylindrical hub opening 120. The wall 114 of the central hub 110 extends from a first end 113 to a second end 115. An annular inlet chamfer 117 is formed at the first end 113. Additionally, the wall 114 includes an increased diameter relief groove 119 adjacent the shoulder 122.

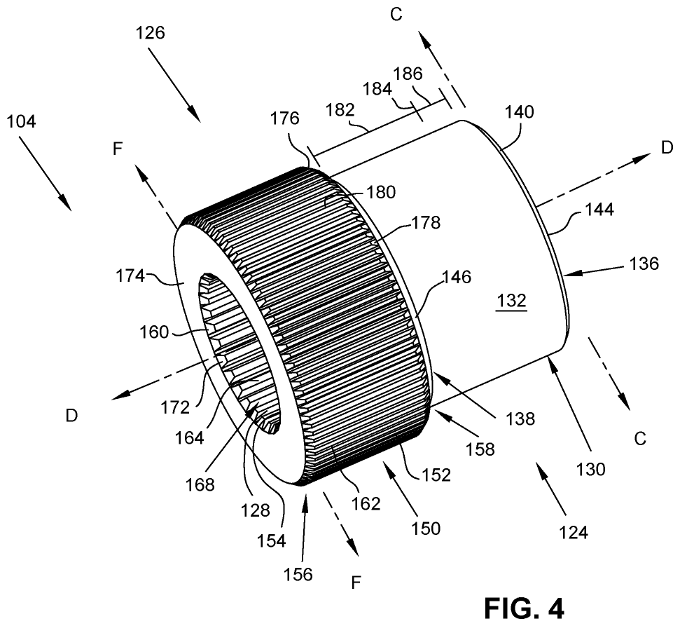

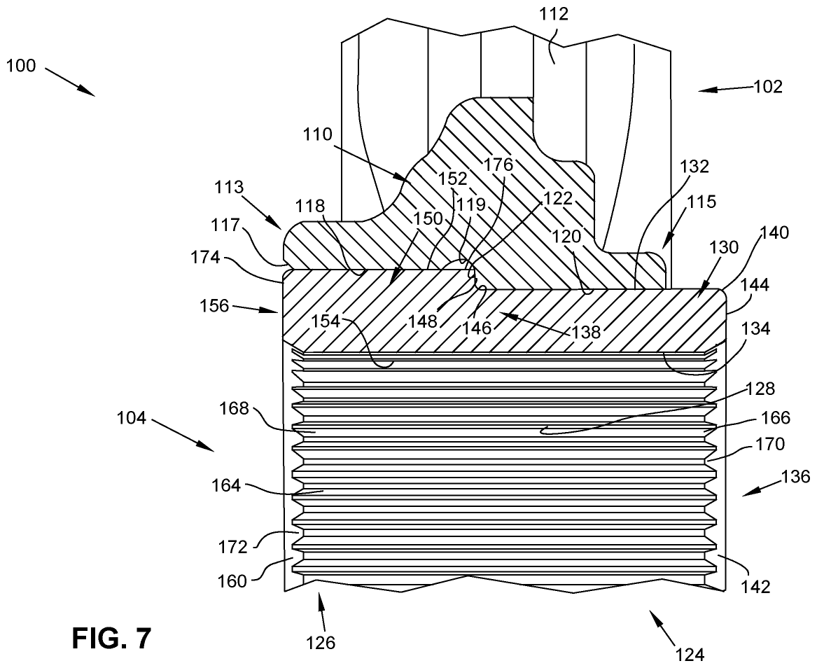

Referring now to FIG. 4, a perspective view of the hub 104 of the sprocket assembly 100 is shown. The hub 104 generally includes an alignment portion 124 and an engagement portion 126 which together form an axle opening 128. The alignment portion 124 includes a substantially cylindrical wall 130 having a smooth outer surface 132, an inner surface 134, an outer end 136 and an inner end 138. As shown in FIGS. 4-7, the cylindrical wall 130 also includes an outer annular chamfer 140 between the smooth outer surface 132 and the outer end 136, and an inner annular chamfer 142 between the outer end 136 and the inner surface 134 of the cylindrical wall 130. In this embodiment, the outer end 136 includes a substantially flat surface 144 that lies in a plane C that is substantially perpendicular a longitudinal axis D of the sprocket assembly 100. As best shown in FIGS. 5 and 7, the inner end 138 includes a circumferential groove 146 of reduced diameter relative to the diameter of the smooth outer surface 132. The circumferential groove 146 transitions to a shoulder 148 of the engagement portion 126. The shoulder 148 is substantially flat and lies in a plane E (FIG. 5) that is substantially perpendicular to a longitudinal axis D of the sprocket assembly 100.

As best shown in FIG. 4, the outer surface 132 of the cylindrical wall 130 includes a substantially constant outer diameter first portion 182 between the inner end 138 and a transition 184. The outer diameter of the outer surface 132 tapers (reduces slightly) over a tapering second portion 186 of the cylindrical wall 130 from the transition 184 to the outer annular chamfer 140. The tapering second portion 184 is slightly smaller than the inner diameter B (FIG. 5) of the second cylindrical opening 120 of the central hub 110 to act as an alignment feature as the alignment portion 124 of the hub 104 is inserted into the sprocket 102 as described below. The slightly larger substantially constant outer diameter first portion 182 is then press fit into the second cylindrical opening 120 of the central hub 110 as the hub 104 is forced further into the second cylindrical opening 120.

Referring now to FIGS. 4 and 5, the engagement portion 126 includes a substantially cylindrical wall 150 having an outer surface 152, an inner surface 154, an outer end 156 and an inner end 158. The substantially cylindrical wall 150 also includes an inner annular chamfer 160 between the outer end 156 and the inner surface 154. The outer surface 152 includes a plurality of forming splines 162 that extend between the outer end 156 and the inner end 158 in substantially parallel relationship to one another and to the longitudinal axis D of the sprocket assembly 100 as is further described below. The outer end 156 of the cylindrical wall 150 includes a substantially flat surface 174 that lies in a plane F that is substantially perpendicular to the longitudinal axis D of the sprocket assembly 100.

As best shown in FIG. 5, the inner surface 154 of the engagement portion 126 and the inner surface 134 of the alignment portion 124 include a plurality of driving splines 164 that extend between the outer end 156 of the engagement portion 126 and the outer end 136 of the alignment portion 124. As the driving splines 164 are continuous and the axle opening 128 of the hub 104 is of constant diameter from the outer end 156 of the engagement potion 126 and the outer end 136 of the alignment portion 124, the inner surface 134 of the alignment portion 124 and the inner surface 154 of the engagement portion 126 may be considered one surface.

The driving splines 164 are substantially parallel to one another and to the longitudinal axis D of the sprocket assembly 100. Each driving spline 164 includes a first end 166 adjacent the outer end 136 of the alignment portion 124 and a second end 168 adjacent the outer end 156 of the engagement portion 126. The first ends 166 of the driving splines 164 include a triangular surface 170 that is continuous with the inner annular chamfer 142 of the alignment portion 124. Similarly, the second ends 168 of the driving splines 164 include a triangular surface 172 that is continuous with the inner annular chamfer 160 of the engagement portion 126. As should be apparent from the foregoing, the driving splines 164 are sized and positioned to correspond to outer splines (not shown) formed on an outer surface (not shown) of the axle 18 of the vehicle 10. In this manner, the driving splines 164 are configured to mesh with the outer splines of the axle 18 to transfer torque from the hub 104 to the axle 18 of the vehicle 10.

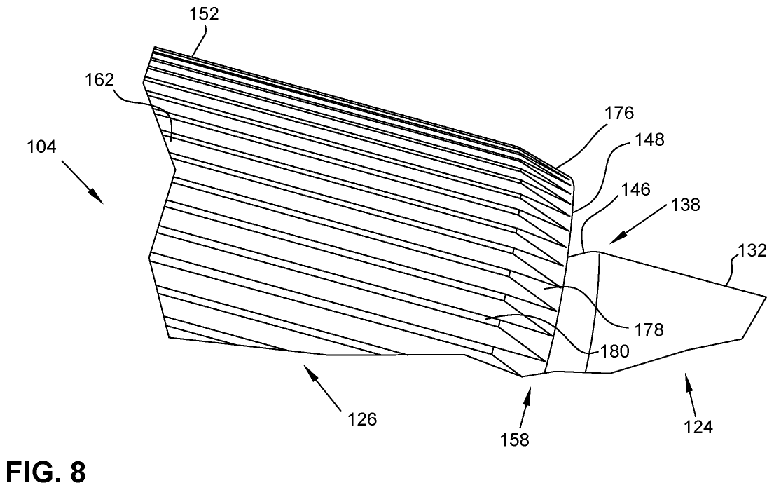

As best shown in FIGS. 5 and 8, the inner end 158 of the engagement portion 126 includes an outer annular chamfer 176 adjacent the shoulder 148. The outer annular chamfer 176 extends into the plurality of splines 162 such that each of the plurality of splines 162 includes a triangular surface 178 adjacent the inner end 158 of the engagement portion 126.

Each of the splines 162 includes a peak 180 that extends the length of the spline 162 between the outer end 156 of the engagement portion 126 and the triangular surface 178 adjacent the inner end 158 of the engagement portion 126. The peaks 180 define an outer diameter of the engagement portion 126.

In certain embodiments of the sprocket assembly 100 of the present disclosure, the hub 104 is formed from a first material such as steel, more specifically ferritic nitrocarburized steel, and the sprocket 102 is formed from second material that is less durable than the first materials, such as aluminum. Each component (the hub 104 and the sprocket 102) may be separately manufactured. The steel hub 104 with the steel driving splines 164 is highly durable and capable of withstanding the shear loads associated with torque transfer to the axle 18. The hub 104 is joined with the sprocket 102 in the manner described below. The combination of the steel hub 104 and the aluminum sprocket 102 provides a sprocket assembly 100 that is lighter that a sprocket assembly made entirely of steel (because the sprocket 102 is made from aluminum) and sufficiently strong and durable to withstand the high shear loads associated with transferring torque to a driven axle 18 of a vehicle 10 such as an autocycle.

The hub 104 is joined with the sprocket 102 by forcing the hub 104 into the hub opening 116 formed by the wall 114 of the central hub 110 of the sprocket 102. More specifically, and primarily referring to FIGS. 4 and 5, the hub 104 is oriented such that the alignment portion 124 of the hub 104 is positioned to enter the first cylindrical hub opening 118 of the central hub 110. The alignment portion 124 is moved freely into the first cylindrical hub opening 118 as the outer diameter of the smooth outer surface 132 of the alignment portion 124 is smaller than the diameter A of the first cylindrical hub opening 118. Eventually, the outer end 136 of the alignment portion 124 engages the second cylindrical hub opening 120. More specifically, the outer annular chamfer 140 of the cylindrical wall 140 engages the annular inlet chamfer 121 adjacent the shoulder 122 and the second cylindrical hub opening 120. As the diameter B of the second cylindrical opening 120 is slightly smaller than the diameter of the smooth outer surface 132 of the alignment portion 124, the outer annular chamfer 140 and the annular inlet chamfer 121 function as lead in surfaces to ensure that the alignment portion 124 is aligned with the longitudinal axis of the sprocket assembly 100 as it begins to be forced into the second cylindrical hub opening 120. The tapering second portion 186 of the outer surface 132 of the alignment portion 124 also functions as a lead in or alignment feature as the alignment portion 124 of the hub 104 is forced into the second cylindrical hub opening 120. FIG. 5 shows the alignment portion 124 near the beginning of the press fit engagement between the substantially constant outer diameter first portion 182 of the smooth outer surface 132 and the inner surface 125 of the second cylindrical hub opening 120. As shown, the alignment portion 124 is aligned and functioning as a pilot for the engagement portion 126 of the hub 104 well before the engagement portion 126 engages the inner surface 123 of the first cylindrical hub opening 118.

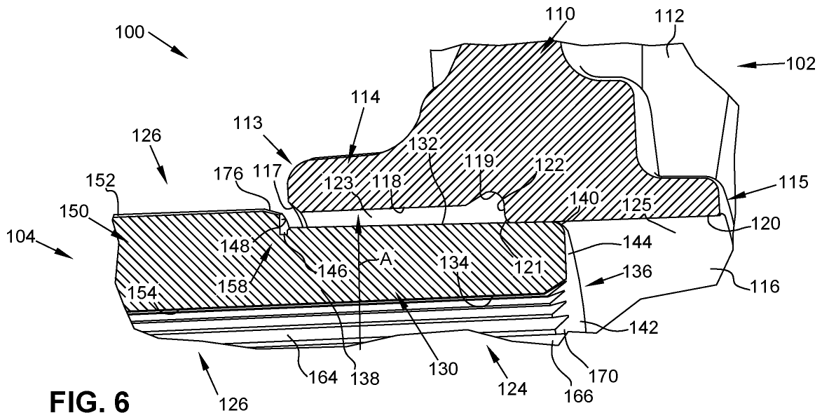

As best shown in FIG. 6, as the hub 104 is pressed farther into the central hub 110 of the sprocket 102, the outer annular chamfer 176 at the inner end 158 of the engagement portion 126 engages the annular inlet chamfer 117 at the first end 113 of the wall 114 of the central hub 110 of the sprocket 102. The outer annular chamfer 176 and the annular inlet chamfer 117 function as lead in surfaces to provide gradual engagement between the triangular surfaces 178 of the splines 162 and the inner surface 123 of the first cylindrical hub opening 118. As the hub 104 is pressed farther still into the central hub 110 of the sprocket 102, the alignment portion 124 continues to maintain the hub 104 in alignment with the longitudinal axis D of the sprocket assembly 100 as the splines 162 of the engagement portion 126 of the hub 104 press into the softer inner surface 123 of the first cylindrical opening 118 to form engagement splines.

As the steel forming the splines 162 is substantially harder than the aluminum forming the inner surface 123 of the first cylindrical opening 118, the splines 162 cause the aluminum inner surface 123 of the first cylindrical opening 118 to flow or form or extrude around the splines 162 to form grooves or recesses or engagement splines that match the shape of the splines 162.

Eventually, the hub 104 is fully seated within the central hub 110 of the sprocket 102 as depicted in FIG. 7. As shown, the shoulder 148 of the engagement portion 126 is seated onto the shoulder 122 at the second cylindrical hub opening 120. Any chips or debris generated as the splines 162 form the inner surface 123 of the first cylindrical hub opening 118 is deposited into the relief groove 119 adjacent the shoulder 122 of the second cylindrical hub opening 120 to ensure that there is essentially zero gap between the shoulder 148 and the shoulder 122 when the hub 104 is fully seated within the sprocket 102. When in the fully seated position, torque is transferred from the sprocket 102 to the hub 104 through the press fit engagement between the inner surface 125 of the second cylindrical hub opening 120 and the smooth outer surface 132 of the alignment portion 124 and through the zero-clearance engagement between the grooves or recesses formed in the inner surface 123 of the first cylindrical hub opening 118 and the splines 162 of the engagement portion 126. The torque is then transferred from the hub 104 to the axle 18 of the vehicle through the driving splines 164 of the hub 104. It should be understood that the press fit engagement between the inner surface 125 of the second cylindrical hub opening 120 and the smooth outer surface 132 of the alignment portion 124 can transfer lower torque levels before the engagement between the inner surface 123 of the first cylindrical hub opening 118 and the splines 162 is required.

It should be understood from the foregoing that splines 162 of the hub 104 may be formed to result in a zero-gap engagement between a large number of fine-toothed splines 162 as described above and the formations they create in the inner surface 123 of the first cylindrical hub opening 118. This zero-gap engagement essentially eliminates backlash. Also, as a large number of splines 162 carry the load carried by the sprocket assembly 100, the spline rating can be relatively high. Moreover, the splines 162 of the present sprocket assembly 100 may be reconfigured to define a different diameter to accommodate different sprocket configurations independent of the diameter of the smooth outer surface 132 of the alignment portion 124.

While this invention has been described as having an exemplary design, the present invention may be further modified within the spirit and scope of this disclosure. For example, some or all of the openings and/or surfaces of the sprocket and the hub described above as being cylindrical may instead have some other shape. That is, instead of having a circular cross-section, some or all of the above-described openings and/or surfaces could have an oval cross-section, a rectangular cross-section, a triangular cross-section, an irregular cross-section or a shape having some other cross-section. This application is therefore intended to cover any variations, uses, or adaptations of the invention using its general principles. Further, this application is intended to cover such departures from the present disclosure as come within known or customary practice in the art to which this invention pertains.

What is claimed is:

1. A sprocket assembly, comprising:
a sprocket having an outer wheel with engaging members connected to a central hub including a first hub opening having a first diameter and a second hub opening having a second diameter that is less than the first diameter; and
a hub including an alignment portion and an engagement portion that together define an axle opening for receiving an axle of a vehicle, the alignment portion including a smooth outer surface sized to be press fit into the second hub opening, and the engagement portion including a plurality of forming splines positioned to deform an inner surface of the first hub opening as the alignment portion is press fit into the second hub opening to form engagement splines on the inner surface that correspond to the splines;
wherein the hub is formed from a first material and the sprocket is formed from a second material that is less durable than the first material.

2. The sprocket assembly of claim 1, wherein the first and the second hub openings are substantially cylindrical.

3. The sprocket assembly of claim 1, wherein the central hub includes a wall that defines the first and the second hub openings and a shoulder positioned between the first and the second hub openings.

4. The sprocket assembly of claim 3, wherein the hub includes a shoulder positioned between the engagement portion and the alignment portion, the shoulder of the hub engaging the shoulder of the central hub when the hub is fully seated within the sprocket.

5. The sprocket assembly of claim 1, wherein the central hub includes a wall that defines a relief groove between the first hub opening and the second hub opening, the relief groove being positioned to receive debris formed as the forming splines deform the inner surface of the first hub opening.

6. The sprocket assembly of claim 1, wherein the alignment portion includes a cylindrical wall having an outer annular chamfer adjacent an outer end of the cylindrical wall, the outer annular chamfer providing a lead in surface as the alignment portion is pressed into the first cylindrical opening of the central hub.

7. The sprocket assembly of claim 1, wherein the alignment portion includes a cylindrical wall having a first portion of substantially constant diameter and a second portion that tapers with distance from the first portion toward an outer end of the cylindrical wall.

8. The sprocket assembly of claim 1, wherein the engagement portion includes a cylindrical wall having an outer surface including the forming splines, an inner surface corresponding to the axle opening, an inner end and an outer end.

9. The sprocket assembly of claim 8, wherein the alignment portion includes an inner surface, the inner surface of the alignment portion and the inner surface of the engagement portion including a plurality of driving splines configured to engage corresponding splines on an outer surface of the axle.

10. The sprocket assembly of claim 8, wherein the inner end of the cylindrical wall of the engagement portion includes an outer annular chamfer and the first hub opening includes an annular inlet chamfer, the outer annular chamfer and the annular inlet chamfer providing lead in surfaces as the engagement portion is pressed into the first hub opening.

11. The sprocket assembly of claim 1, wherein the engagement portion includes a cylindrical wall having an inner end and an outer end, and an outer diameter of the engagement portion being defined by the forming splines.

12. The sprocket assembly of claim 1, wherein the first material is steel and the second material is aluminum.

13. A method of forming a sprocket assembly, comprising:
forming a hub from a first material;
forming a sprocket from a second material that is less durable than the first material; and
press fitting the hub into the sprocket;
wherein press fitting includes press fitting a smooth outer surface of an alignment portion of the hub into a second hub opening of the sprocket and press fitting a plurality of forming splines disposed on an outer surface of an engagement portion of the hub into an inner surface of a first hub opening of the sprocket, the forming splines deforming the inner surface of the first hub opening, the first hub opening having a diameter that is larger than a diameter of the second hub opening.

14. The method of claim 13, wherein the press fitting of the smooth outer surface of the alignment portion of the hub occurs before the press fitting of the plurality of forming splines of the engagement portion of the hub such that the press fitting of the smooth outer surface of the alignment portion maintains the hub in alignment with a longitudinal axis of the sprocket assembly.

15. A sprocket assembly, comprising:
a sprocket including a central hub defining a hub opening; and
a hub including an alignment portion and an engagement portion that together define an axle opening for receiving an axle of a vehicle, the alignment portion including a smooth outer surface press fit into the one portion of the hub opening, and the engagement portion including a plurality of forming splines engaged with an inner surface of the hub opening formed by the forming splines as the hub is press fit into the central hub of the sprocket;
wherein the hub is formed from a first material and the sprocket is formed from a second material that is less durable than the first material.

16. The sprocket assembly of claim 15, wherein the hub opening includes a first cylindrical hub opening having a first diameter and a second cylindrical hub opening having a second diameter that is smaller than the first diameter.

17. The sprocket assembly of claim 15, wherein the central hub includes a wall that defines a first hub opening, a second hub opening and a shoulder positioned between the first hub opening and the second hub opening.

18. The sprocket assembly of claim 17, wherein the hub includes a shoulder positioned between the engagement portion and the alignment portion, the shoulder of the hub engaging the shoulder of the central hub when the hub is fully seated within the sprocket.

19. The sprocket assembly of claim 15, wherein the central hub includes a wall that defines a relief groove adjacent the one portion of the hub opening, the relief groove being positioned to receive debris formed as the forming splines deform the inner surface of the hub opening.

20. The sprocket assembly of claim 15, wherein the engagement portion includes a cylindrical wall having an inner end and an outer end, an outer diameter of the engagement portion defined by the forming splines is substantially constant.

21. The sprocket assembly of claim 15, wherein the first material is steel and the second material is aluminum.
